(19) United States
(12) Patent Application Publication
(10) Pub. No.: US 2015/0368379 A1
(43) Pub. Date: Dec. 24, 2015

(54) SYNTHESIZING HYPERBRANCHED POLYMERS WITH UNIFORM STRUCTURE IN CONFINED SPACE

(71) Applicants: Haifeng Gao, Granger, IN (US); Ke Min, Granger, IN (US)

(72) Inventors: Haifeng Gao, Granger, IN (US); Ke Min, Granger, IN (US)

(73) Assignee: THE UNIVERSITY OF NOTRE DAME DU LAC, Notre Dame, IN (US)

(21) Appl. No.: 14/311,288

(22) Filed: Jun. 21, 2014

(51) Int. Cl. C08F 22/10; C08F 2/10; C08F 4/10

(52) U.S. Cl. CPC C08F 22/10; C08F 4/10; C08F 2/10

(57) ABSTRACT

Hyperbranched polymers are synthesized with uniform structure based on one pot polymerization technique in confined space with nanometer scale, e.g. micelles in a microemulsion system. The segregated space in micelles or polymerizing nanoparticles is expected to regulate the growth of hyperbranched polymers by confining polymer-polymer reaction inside each individual locus. The obtained hyperbranched polymers have uniform size, similar to the size of nanoparticles, as indicated by a narrow molecular weight distribution of the polymers.

### CROSS-REFERENCE TO RELATED APPLICATIONS

This present application claims the benefit of U.S. Provisional Patent Application 61/837,889, filed on Jun. 21, 2013, and entitled “SYNTHESIZING BRANCHED POLYMERS WITH UNIFORM STRUCTURE IN CONFINED SPACE.”, which is incorporated herein by reference in its entity.

### FIELD OF THE DISCLOSURE

The present disclosure is directed to the synthesis of hyperbranched polymers with a uniform structure by using a confined space method such as microemulsion.

### BACKGROUND

Dendrimers and hyperbranched polymers have received much attention recently due to their three-dimensional dendritic architectures and unusual properties. Dendrimers are a promising candidate in the fields of highly precise nanotechnology (including electronics, photonics, lithography, patterning, templating, etc.), catalysis and biomedicine. The perfect structure of dendrimers results from the strict synthetic procedures, usually a series of stepwise coupling and activation steps followed by purification steps, each step requiring an absolute control. Accordingly a high cost of labor and energy is required, which hinders a widespread utilization of dendrimers.

Synthetic techniques used to prepare a hyperbranched polymer can be divided into two major categories. The first category contains methods of a double-monomer methodology in which two types of monomers or a monomer pair generate hyperbranched polymers. The second category is based on single-monomer methodology in which hyperbranched polymers are formed from an ABₙ monomer, i.e. inimer. Out of the second category, a radical polymerization technique, Self Condensing Vinyl Polymerization (SCVP) has been recently developed for hyperbranched polymer synthesis. In this polymerization technique, a hyperbranched polymer can be straightforwardly synthesized by a radical polymerization of an inimer AB* (having an initiator part B* and vinyl monomer part A in one molecule).

By using SCVP technique, a hyperbranched polymer can be easily synthesized in a one-pot reaction from a single monomer. However, the obtained hyperbranched polymers generally have very broad molecular weight distributions, because polymerization generates multifunctional chains that subsequently undergo random polymer-polymer reactions and produce large branched structure. These uncontrolled reactions lead to polymers with broad molecular weight distribution and ill-defined structure. It remains a challenge to synthesize hyperbranched polymers with uniform structures.

### SUMMARY

Hyperbranched polymers synthesized by traditional methods in either bulk or solution have a broad size distribution because of uncontrolled multifunctional polymer-polymer reactions. To produce hyperbranched polymers with uniform structures, a synthetic method in confined space was utilized. In particular, microemulsion medium was used as an example of a confined space to carry polymerization of an inimer bearing a polymerizable vinyl group and a transferrable atom for radical polymerization initiation purpose. Because polymerization occurs only in microemulsion latexes, polymer-polymer interactions are confined in the latexes and produced hyperbranched polymer has a molecular weight of 50,000 and 5,000,000. The narrowly distributed microemulsion latexes produced hyperbranched polymers with a narrow molecular weight distribution, indicated by PDI between 1.0 and 1.5.

### BRIEF DESCRIPTION OF THE DRAWINGS

FIG. 1 shows a schematic illustration of using confined space, e.g. micelles or polymerizing particles, to prevent inter-particle polymer-polymer reactions.

FIG. 2 shows hydrodynamic sizes of hyperbranched polymer synthesized by ATRP of Inimer 1 in microermulsion before purification in water and after purification in THF.

FIG. 3 shows the GPC traces of hyperbranched polymers synthesized via ATRP of Inimer 1 in solution and in microemulsion, based on linear PMMA standards in THF.

FIG. 4 shows size change of hyperbranched polymer during degradation of after adding tributylphosphine (nBu)₃P.

FIG. 5 is a schematic illustration of hyperbranched polymer used as macroinitiator for chain extension reactions of a new monomer.

FIG. 6 shows hydrodynamic diameters (Dₕ) of (1) HS1, hyperbranched polymer synthesized via ATRP in microemulsion after purification in THF; (2) HS1-PtBA, product of HS1 used as macroinitiator for tBA chain extension, in THF; and (3) hydrolysis product H81-PAA in pH=7 water.

### DETAILED DESCRIPTION

The present disclosure may be embodied in many different forms and should not be construed as limited to the embodiments set forth herein; rather, these embodiments are provided so that this disclosure will convey the full scope of the invention to those skilled in the art.

### DEFINITIONS

As used in the specification and appended claims, the singular forms “a,” “an,” and “the” include plural referents unless the context clearly dictates otherwise. Thus, for example, reference to “a polymer” may include more than one polymer, reference to “a substituent” may include more than one substituent, reference to “a monomer” may include multiple monomers, and the like.

In describing and claiming the present invention, the following terminology will be used in accordance with the definitions set out below. Where the definition of terms departs from the commonly used meaning of the term, applicant intends to utilize the below definitions, unless specifically indicated.

For the purpose of the present disclosure, “confined space” is a term opposite to “open space” or “infinite space”. Polymerizations are designated to occur in pre-designed micron-sized or nano-sized reactors with a well-defined boundary rather than in an infinite space. Each reactor is highly localized and relatively independent, and mass transfer between reactors can be ignored.

The term “polymer” refers to a chemical compound that comprises linked monomers, and that may or may not be linear, the term “polymer” includes homo-polymer and copolymers. “Optional” or “optionally” means that the subsequently described circumstance may or may not occur, so that the description includes instances where the circumstance occurs and instances where it does not. For example, the phrase “optionally substituted” means that a non-hydrogen substituent may or may not be present, and, thus, the description includes structures wherein a non-hydrogen substituent is present and structures wherein a non-hydrogen substituent is not present.

“Dendrimer” is defined as a monodisperse polymer with repetitive branches, and it is essentially characterized by its structural perfection. Dendrimer is symmetric around a core and often adopts a spherical three-dimensional morphology.

The term “abbreviation atom transfer radical polymerization” or “ATRP” refers to a transition metal mediated controlled/living radical polymerization process. In ATRP, a metal-based catalyst provides equilibrium between an active, and therefore propagating polymer, and an inactive form of a polymer (“dormant form”). By rationally selecting a catalyst, an equilibrium strongly preferred the dormant form of polymer, and therefore side reactions are suppressed and a uniform growth of polymer chain is attained.

ATRP uses simple initiators, mainly alkyl halides. Alkyl halides used as initiators can contain one or more halogen atoms. Metal-based catalysts play an important role in ATRP and a catalyst is generally composed of a transition metal and a coordinating ligand. The transition metal can exist in two different oxidation states. The lower oxidation state metal complex/catalyst can react with the initiator, yielding active radicals and the corresponding higher oxidation state metal complex/catalyst. The latter complex can transfer the active radicals to the dormant species and regenerate the low oxidation state complex.

ATRP has been described by Matyjaszewski in U.S. Pat. Nos. 5,763,548 and 5,807,937 and in the Journal of American Chemical Society, vol. 117, page 5614 (1995), as well as in ACS Symposium Series 768 Handbook of Radical Polymerization, Wiley: Hoboken 2002, Matyjaszewski, K., and Davis, T. P., editors (Handbook of Radical Polymerization), specifically Chapter 11.

The terms “Self Condensing Vinyl Polymerization” or “SCVP” refers to a polymerization involving a monomer with both a polymerizable vinyl group and a group capable of initiating the polymerization of vinyl group, first reported by Frechet, et al. (U.S. Pat. Nos. 5,587,441 and 5,587,446, and in the journal Science, vol 269, page 1080). This polymerization combines features of a classical vinyl polymerization process with those of a polycondensation because growth is accomplished by the coupling of reactive oligomers. Highly branched structures can be attained through this polymerization technique.

The term “inimer” refers to a molecule bearing both a “monomer”, group that can participate in polymerization, and an “initiator” group that can initiate polymerization of a monomer.

A “hyperbranched polymer” refers to a polymer with a densely branched structure and usually a large number of reactive groups. In many respects, a hyperbranched polymer is considered an analog of dendrimer. Although hyperbranched polymers have less perfect structure compared to dendrimers (e.g., hyperbranched polymers do not contain a molecular core and usually have a broad distribution of molecular shapes and sizes), the synthesis of such a polymer is relatively simple. Usually a one-pot, one-shot, relatively rapid polymerization reaction can lead to a useable hyperbranched polymer in a reasonable quantity. Hyperbranched polymers are considered suitable candidates for large scale material engineering applications, such as topical drug delivery, biotechnical reactor-based processes, special functional and protective coatings, sensors, decontamination and antifouling surfaces, biomimetic materials, etc.

For the purposes of the present disclosure, the term “microemulsion” refers to two immiscible liquid phases in a state in which one phase assumes a dispersed medium comprising drops with dimensions on the order of tm and below and the other phase assumes a continuous phase surrounding the drops.

Hyperbranched polymers are polymers with densely branched structure and a large number of end groups. They belong to a class of synthetic tree-like macromolecules called dendritic polymers.

Molecular weight is a very important parameter of a polymer. Unlike small molecules, the molecular weight of a polymer is not one unique value since a given synthetic polymer has a distribution of molecular weights and the distribution highly depends on production methods of a polymer. Polymers are often characterized as having an average molecular weight. There are optional methods to calculate an average molecular weight. Number-average molecular weight, Mₙ, is calculated by the total weight of polymer divided by the number of polymer molecules. It is determined by measuring the molecular weight of n polymer molecules, summing the weights, and being divided by n, as illustrated in the equation below:

$${M}_{n} = \frac{Σ {N}_{i} {M}_{i}}{Σ {N}_{i}}$$

where Mᵢ is the molecular weight of a chain and Nᵢ is the number of chains of that molecular weight.

Weight average molecular weight of polymers is defined by the equation below:

$${M}_{w} = \frac{Σ {N}_{i} {M}_{i}^{2}}{Σ {N}_{i} {M}_{i}}$$

Molecular weight distribution is indicated by polydispersity index (PDI) calculated as the ratio of the weight average molecular weight to the number average molecular weight.

Measurement of average molecular weight and molecular weight distribution of polymers were conducted on gel permeation chromatography (GPC). A refractive index (RI) detector is generally efficient for a linear polymer, while for a hyperbranched polymer, a multi angle laser light scattering (MALLS) detector can provide more comprehensive information.

The term “uniform structure” in this disclosure refers to a synthesized polymer with a narrow distribution on its size, and on its molecular weight. The narrow molecular weight distribution is usually indicated by PDI<1.5.

In the present disclosure, “conversion” or “monomer conversion” is a percentage of monomers that have been incorporated in polymer chains out of the entire monomers that was initially added to the polymerization reaction.

### DESCRIPTION

According to this application, a hyperbranched polymer with a uniform structure was synthesized by using SCVP in confined space. The concept of this application was to improve the structure control through controlling the molecular weight distribution of the hyperbranched polymers. This was achieved by confining the polymerization in small uniform-sized segregated spaces, and therefore the polymer-polymer interaction from two loci is highly suppressed and the interaction in the same loci is highly promoted. The produced hyperbranched polymer had a uniformed structure as indicated by the narrowly distributed molecular weight.

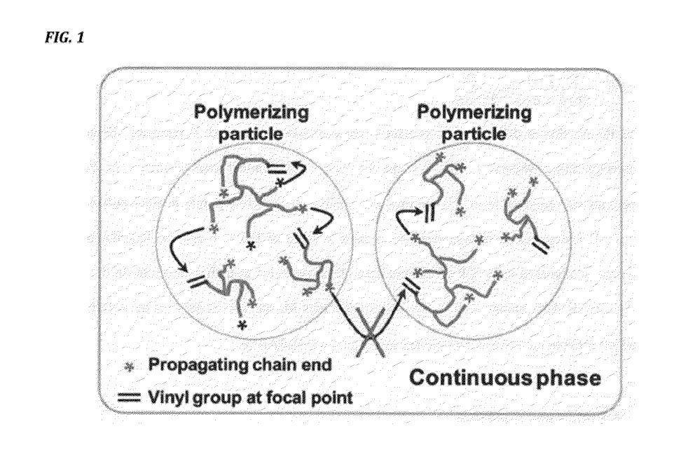

The polymerization in this application was an SCVP of inimer, through an ATRP process. However, the type of polymerization is certainly not limited and may actually be any polymerization techniques that can lead to a hyperbranched polymer. Because the polymerization is confined in the defined loci, the final obtained polymer will have a uniformed structure regardless of the detailed polymerization techniques. The schematic illustration of the concept of the present disclosure is shown in FIG. 1.

The confined spaces used in the method were a microemulsion wherein the size of the microemulsion micelles is generally between 10-50 nm. The size of the final obtained hyperbranched polymer can be tunable by adjusting the size of microemulsion micelles, which can be done by varying the ratio of water, inimer, an optional solvent and a surfactant.

Choice of a confined space is not limited to microemulsion, though. For instance, other dispersed polymerization media, for example, emulsion or miniemulsion, surfactant-free emulsion or miniemulsion, and chambers in molecular sieves can also serve as confined space for polymerization. For a hydrophilic monomer/inimer, an inverse microemulsion would be a preferred choice, with oil as a continuous phase and aqueous solution of monomer/inimer as a dispersed phase. A dimension of resulting polymers can surely be determined by the size of dispersed media and molecular sieve chambers, respectively.

One embodiment of the application includes hyperbranched polymer synthesis through SCVP of inimers. A general structure of an inimer is:

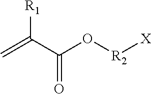

wherein R₁ is —H or —CH₃. R₂ can include a linear, branched or cyclic alkylene group having 1 to 30 carbon atoms, which may include an ester bond, an acetal bond or a disulfide bond. X is a halogen group, e.g. —CI or —Br.

Specific inimers useful in the present disclosure include those shown in Table 1:

TABLE 1
Inimers of the present disclosure

| Inimer | Structure |
|---|---|
| 1 | 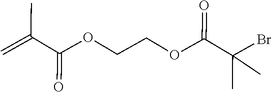 |
| | Inimer 1 |
| 2 | 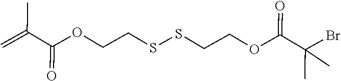 [SMILES: C=C(C)C(=O)OCCSSCCOC(=O)C(C)(C)Br] |
| | Inimer 2 |
| 3 | 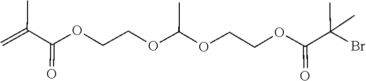 [SMILES: C=C(C)C(=O)OCCOC(C)OCCOC(=O)C(C)(C)Br] |
| | Inimer 3 |
| 4 | 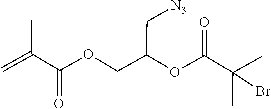 [SMILES: C=C(C)C(=O)OCC(CN=[N+]=[N-])OC(=O)C(C)(C)Br] |
| | Inimer 4 |
| 5 | 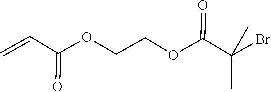 |
| | Inimer 5 |

These inimers can generally be synthesized through esterification reactions from the corresponding acyl chlorides (or bromides) and alcohols. For instance, Inimer 1 was synthesized through the route shown below:

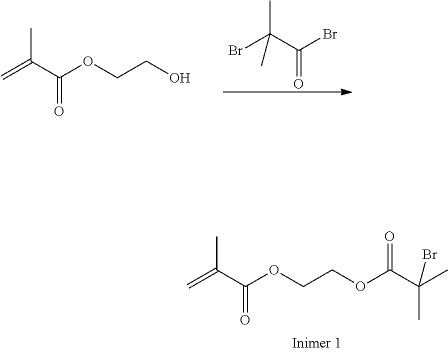

Since this inimer has radically polymerizable vinyl monomer group, and bromide initiating group, they are good candidates for SCVP, forming hyperbranched polymers.

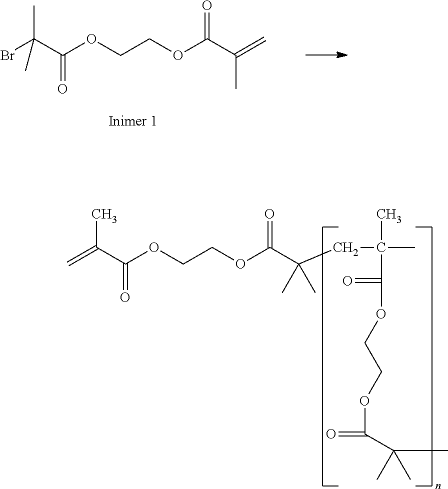

During polymerization, ATRP was applied since ATRP can provide better control and living characteristics to the formed polymers. ATRP is a versatile polymerization technique that has been successfully applied in aqueous dispersed media including microemulsion. Before polymerization, Inimer 1, catalyst CuBr₂ and ligand bis(2-pyridylmethyl) octadecylamine (BPMODA) formed an oil phase, which was mixed with the aqueous phase containing surfactant Brij 98 under magnetic stirring, forming a stable microemulsion. The microemulsion has an aqueous continuous phase and the oil phase is a dispersed phase composed on nanometer scale micelles. After deoxygenating the microemulsion with nitrogen gas, the polymerization of Inimer 1 was started by injecting an aqueous solution of reducing agent sodium ascorbate to the microemulsion. After polymerization, the hyperbranched polymers were purified by precipitation of microemulsion in methanol. The obtained hyperbranched polymers are dried under vacuum and subject to molecular weight analysis.

Inimer 1 comprises an ester group which is liable (degradable by hydrolysis. Inimer 2 comprises a disulfide group that is liable under a reducing environment. Inimer 3 comprises an acetal group that is liable under acidic condition (pH<5.4). Inimer 4 comprises azide groups that is reactive for attaching guest molecules.

Unlike ideal dendrimers, which have an extremely narrow molecular weight distribution, hyperbranched polymers generally have a broad distribution and this distribution gets drastically wider as monomer conversion increases during SCVP. A solution SCVP of Inimer 1 resulted in hyperbranched polymers of number average molecular weight of 3.8×10⁴, as measured by MALLS GPC and the molecular weight distribution was ˜4.72.

However, in the present disclosure, SCVP of Inimer 1 in microemulsion leads to a narrowly distributed hyperbranched polymer, with a molecular weight of 1.47×10⁶ and a molecular weight distribution of only 1.24. The confined space of microemulsion micelles/droplets successfully suppresses the polymer-polymer reactions across micelles/particles. At high monomer conversion, each nanoscale particle only contained one hyperbranched polymer. These polymers have a narrow distribution because of a narrowly dispersed size of microemulsion particles.

To maintain a good control over polymerization of inimers in microemulsion, certain parameters are generally preferred, including a rational selection of reaction conditions, ligands, surfactants, solvents and reducing agents.

Controlled living radical polymerization, e.g. ATRP, of vinyl monomers requires that special conditions be maintained to ensure that undesirable side reactions such as chain transfer or termination are suppressed if not avoided. Use of standard precautions, such as those described in the review by Sawamoto, Prog. Polym. Sci., 16, 111-172 (1991), is preferred. For example, polymerization is generally carried out in the absence of oxygen. Conditions must also be maintained to prevent elimination reactions.

In ATRP, catalysts, especially ligands of the catalysts, and reducing agents for transferring the catalysts from the oxidative status to reductive status, have to be rationally selected to ensure polymerization with a suitable rate and controllability. In particular, the solubility of the ligands must be considered to conduct an ATRP in aqueous dispersed media such as microemulsion. A ligand is sufficiently hydrophobic if a catalyst, or catalyst precursor, remains significantly within the organic phase, i.e. the pre-polymeric particles, and provides an active catalyst complex that provides sufficient control over polymerization to provide an acceptable polymer for an application. A sufficiently hydrophobic ligand will substantially retain catalysts in the higher oxidation state in the oil phase and therefore provide control over polymerization. Because catalysts are not wasted through leaking to aqueous phase, use of a hydrophobic ligand can allow a substantially low level of catalyst to be used.

Primary functions of a ligand include solubilizing a transition metal salt in organic media and adjusting the redox potential and halogenphilicity of a metal center. In certain embodiments, a transition metal catalyst comprising a suitably hydrophobic ligand may be preferred to conduct a well-controlled ATRP in aqueous dispersed media.

Since a surfactant plays a role in determining stability of a microemulsion polymerization, selecting a surfactant has to be carefully considered. In particular, selection of a surfactant has to be compatible with ATRP ingredients in an embodiment. Generally a non-ionic surfactant is preferred to avoid any unwanted interactions between a surfactant and ATRP ingredients. Brij 98 can be used as a non-ionic surfactant.

When conducting a microemulsion ATRP of inimers, an organic solvent is optionally included in the oil phase mixing with inimers and transition metal complexes.

A reducing agent for polymerization may be any reducing agent capable of reducing a transition metal catalyst from a higher of two accessible oxidation states to a lower oxidation state, such as, but not limited to, ascorbic acid, tin octonate, reducing sugars such as fructose, antioxidants, such as those used as food preservatives, for example flavonoids (quercetin), beta carotene (vitamin A), α-tocopherol (Vitamin E), propyl or octyl gallate (triphenol) BHA or BHT, other food preservatives such as nitrites, proplonic acids, sorbates, or sulfates. Reduction of cupric salts to cuprous salts is discussed in U.S. Pat. No. 8,273,823.

Because of the hyperbranched polymer synthesis applied ATRP technique, the obtained hyperbranched polymers still had living characteristics, i.e. they were bearing the dormant initiator species after polymerization. Therefore, these hyperbranched polymers can be used as macroinitiators for further polymerization if more of a second monomer is provided. Since the hyperbranched polymer presents a globular structure, the second monomer forms polymer structures close to the periphery of the hyperbranched polymer and largely determines the solubility of the core-shell polymers.

### EXAMPLES

Materials: Commercially available monomers were purified by passing through a column filled with basic aluminum oxide (Sorbent technologies) to remove inhibitor, or antioxidant, in order to provide consistent reaction kinetics in the presence of oxygen. The purified monomers were stored at −5° C. Inimer 1, 2-((2-bromoisobutyryl)oxy)ethyl methacrylate, was synthesized by a one-step reaction between 2-bromoisobutyryl bromide with 2-hydroxyethyl methacrylate. Bis(2-pyridylmethyl) octadecylamine (BPMODA) was synthesized according to the procedures previously published. CuBr₂ (99.999%, Aldrich), Brij 98 (polyoxyethylene (20) oleyl ether. Aldrich), sodium L-ascorbic acid sodium salt (99%, Alfa Aesar) were used without further purification.

Measurements: Monomer conversions were determined from the concentration of unreacted monomers in the samples periodically removed from the reactions using either a Shimadzu GC-2014 gas chromatograph or Bruker 400 MHz NMR. The GC was equipped with an AOC-20i autosampler, a capillary column (ZB-Waxplus, 30 m×0.53 mm×1.0 μm, Phenomenex) and a FID detector. After filtration through 0.45 [symbol] m filter, the polymer samples were separated by GPC with THF or DMF as eluent. The THF GPC S7 was equipped with Polymer Standards Services (PSS) columns (guard, 105, 103, and 102 Å SDV columns) at 35° C. and the DMF GPC used Polymer Standards Services (PSS) columns (guard, 10⁴, 10³, and 10² Å GRAM 10 columns) at 55° C. Both GPCs were set a flow rate=1.00 ml/min and connected with a differential refractive index (RI) detector (Waters, 2410) using PSS WinGPC 7.5 software. The apparent molecular weights were calculated based on linear polymer standards, such as polystyrene (PS) or poly(methyl methacrylate) (PMMA). The detectors employed to measure the absolute molecular weights of polymers in THF GPC were a RI detector (Wyatt Technology, Optilab T-rEX) and a multi-angle laser light scattering (MALLS) detector (Wyatt Technology, DAWN HELEOS II) with the light wavelength at 658 nm. Absolute molecular weights were determined using ASTRA software from Wyatt Technology with the dn/dc value of Poly(Inimer 1) (0.084 ml/g). 1H NMR spectra, using CDCl3 as solvent, were measured on a Bruker Advance 400 MHz spectrometer at 27° C. The size and zeta potential distribution of the samples was determined by dynamic light scattering (DLS) equipped with a Zetasizer Nano-ZS (He—Ne laser wavelength at 633 nm) and an auto-titrator (Malvem Instruments, Malvem, UK).

### Example 1

### ATRP of Inimer 1 in Microemulsion

In a polymerization of Inimer 1 with [Inimer 1]₀/[CuBr₂]₀/[BPMODA]₀/[sodium ascorbate]₀=70/1/1/0.5, Cu(II) complex was first prepared by dissolving equal molar amounts of CuBr₂ (2.9 mg, 12.8 μmol) and BPMODA ligand (5.8 mg, 12.8 μmol) into 0.25 g Inimer 1 (0.896 mmol) and 0.1 ml methylene chloride at 60° C. After evaporating methylene chloride, the resulting solution was slowly added into 13 ml aqueous solution containing 1 g Brij 98 surfactant to form a thermodynamically stable microemulsion. The microemulsion appearing as transparent bluish solution was purged with nitrogen for 30 minutes before the flask was immersed in an oil bath thermostated at 85° C. 1 ml deoxygenated solution of sodium ascorbate in water was then injected into the reaction to initiate the polymerization. At timed intervals, samples were withdrawn via a syringe fitted with stainless steel needle. A fraction of the sample was diluted with DI water for DLS measurement. The rest was dried in vacuum at room temperature before dissolving in solvents for NMR measurement of vinyl group conversion and THF GPC measurement of polymer molecular weight. After 2 hours, the reaction was stopped by exposure to air. After precipitating the microemulsion in methanol, the hyperbranched polymer can be purified and dried under vacuum before analysis.

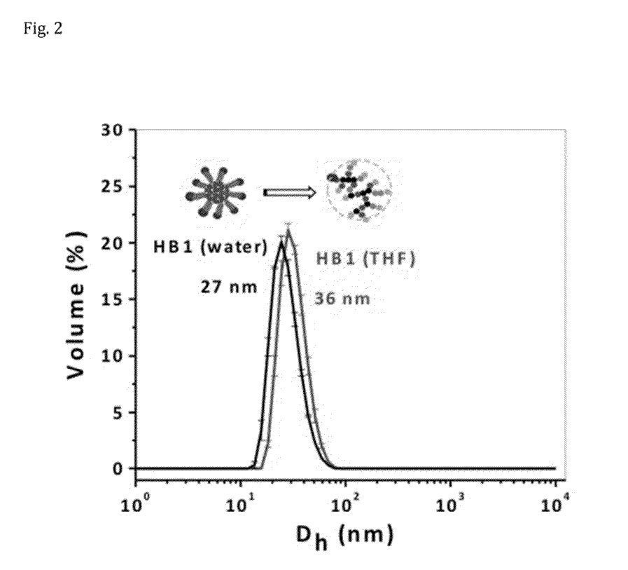

The obtained microemulsion has a hydrodynamic particle size of ˜27 nm in water, measured by a dynamic light scattering instrument. When the purified hyperbranched polymer is re-dispersed in THF, it remained a single distribution under this dynamic light scattering analysis, and the particle size was ˜36 nm, slightly bigger than the microemulsion particle size due to swelling of hyperbranched polymers in THF. The traces of the size measurements in both water and THF can be found in FIG. 2.

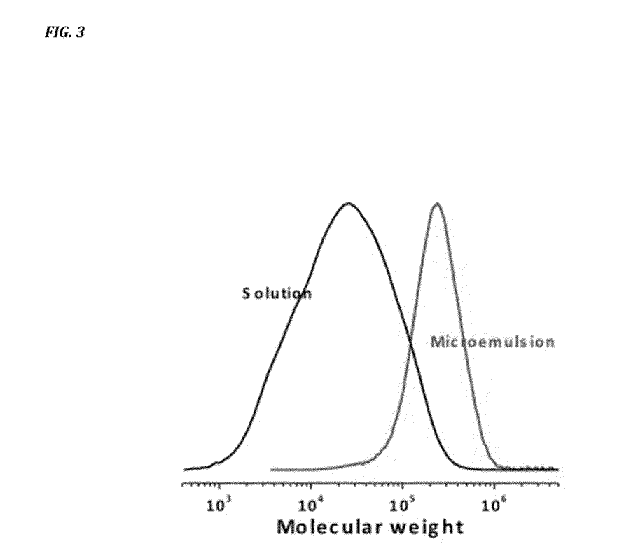

The synthesized hyperbranched polymer had number-average molecular weight of 1.47×10⁶, as measured by THF GPC with MALLS detector, and the molecular weight distribution of this polymer was measured to be 1.24, far narrower than what was produced in bulk. The GPC traces of the hyperbranched polymers from both microemulsion and bulk is illustrated in FIG. 3.

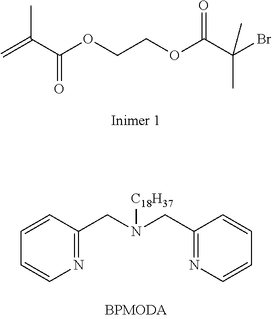

TABLE 2
Information of hyperbranched polymers synthesized in Example 1
and Example 2

| | | | M_{n,MALLS} | M_{n,RI} | M_{w}/ | Dₕ | |
|---|---|---|---|---|---|---|---|
| Medium | Inimer | Conv ^{c} | (×10⁻³) ^{d} | (×10⁻³) ^{e} | Mₙ ^{e} | (nm) ^{f} | CV ^{f} |
| Solution ^{a} | 1 | 95% | 38.0 | 9.72 | 4.72 | | |
| Micro- | 1 | 99% | 1,470 | 140 | 1.24 | 36.0 | 0.12 |
| emulsion ^{b} | | | | | | | |
| Micro- | 2 | 97% | 1,510 | 141 | 1.25 | 34.0 | 0.14 |
| emulsion ^{b} | | | | | | | |

^{a} [Inimer]₀: [CuBr]₀: [CuBr₂]₀: [bpy]₀ = 70:0.95:0.05:2, 1 g of Inimer 1 in 0.3 ml toluene, [Inimer 1]₀ = 2.8 M, 65° C., 9 h;
^{b} [Inimer]₀: [CuBr₂]₀: [BPMODA]₀: [ascorbate]₀ = 70:1:1:0.5, weight ratio of Inimer to Brij98 = 1:4, 1 g Brij98 in 12 g water, 65° C., 2 h;
^{c} Conversions of vinyl groups were determined by ¹H NMR for inimers, OEGMA and by GC for tBA, respectively;
^{d} Number-average molecular weight, measured by THF GPC with MALLS detector;
^{e} Apparent number-average molecular weight and molecular weight distribution, measured by GPC with RI detector, calibration with linear polystyrene (PS) standards for HS1-PtBA and HS2-PtBA and linear PMMA standards for the rest. The mobile phase of GPC was THF except of DMF GPC for HS1-POEGMA;
^{f} Hydrodynamic diameter (Dₕ) and coefficient of variation (CV) determined by DLS in THF (if not stated otherwise).

### Example 2

### ATRP of Inimer 2 (with Degradable Disulfide Crosslinker) in Microemulsion and Degradation of the Hyperbranched Polymers

When the inimer is degradable at certain chemical or physical circumstances, the produced hyperbranched polymer is degradable at the same environments. One example is the use of inimer 2 with a redox degradable disulfide group between the vinyl part and the initiator part of the inimer. The polymerization followed the same stoichiometry as set in Example 1. i.e. [inimer 2]₀/[CuBr₂]₀/[BPMODA]₀/[sodium ascorbate]₀=70/1/1/0.5. Cu(II) complex was first prepared by dissolving CuBr₂ and BPMODA ligand into inimer 2 and 0.1 ml methylene chloride at 60° C. After evaporating methylene chloride, the resulting solution was slowly added into an aqueous solution of Brij 98 surfactant to form a thermodynamically stable microemulsion. The microemulsion appearing as transparent bluish solution was purged with nitrogen for 30 minutes before the flask was immersed in an oil bath thermostated at 65° C. 1 ml deoxygenated solution of sodium ascorbate in water was then injected into the reaction to initiate the polymerization. At timed intervals, samples were withdrawn via a syringe fitted with stainless steel needle. A fraction of the sample was diluted with DI water for DLS measurement. The rest was dried in vacuum at room temperature before dissolving in solvents for NMR measurement of vinyl group conversion and THF GPC measurement of polymer molecular weight.

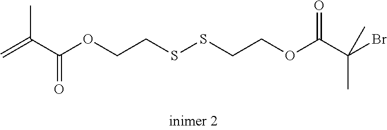 [SMILES: C=C(C)C(=O)OCCSSCCOC(=O)C(C)(C)Br]

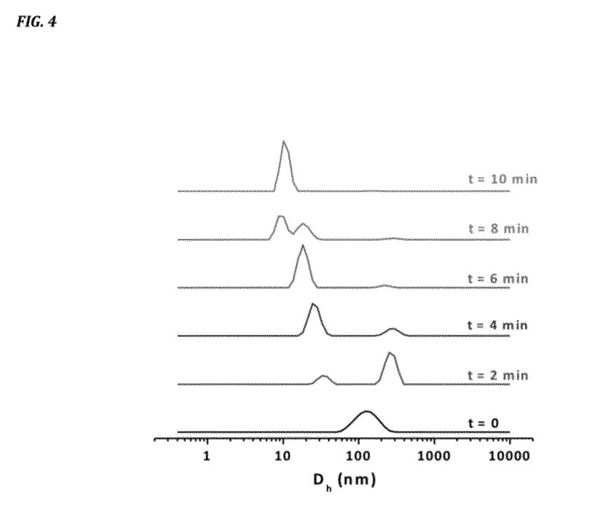

After 2 hours, the reaction was stopped by exposure to air. The hyperbranched polymer was purified by precipitation from methanol and the product was re-dispersed in tetrahydrofuran. The synthesized hyperbranched polymer had number-average molecular weight of 1.51×10⁶, as measured by THF GPC with MALLS detector, and the molecular weight distribution of this polymer was measured to be 1.25. Upon adding reducing agent tributylphosphine, the hyperbranched polymer degraded as shown in size monitoring when the size of the polymer dramatically decreased as time increased. The size measurement record is shown in FIG. 4.

### Example 3

### Hyperbranched Polymer 1 Used as Initiator for tBA for Continuing Chain Extension Polymerization

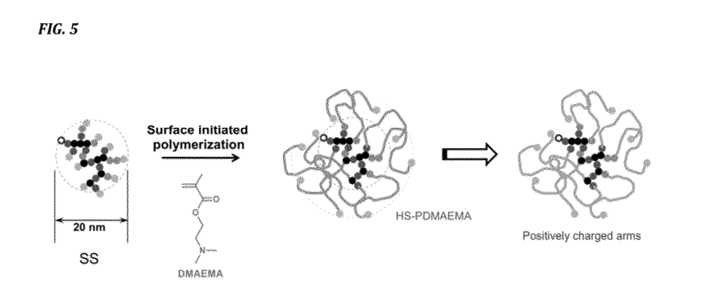

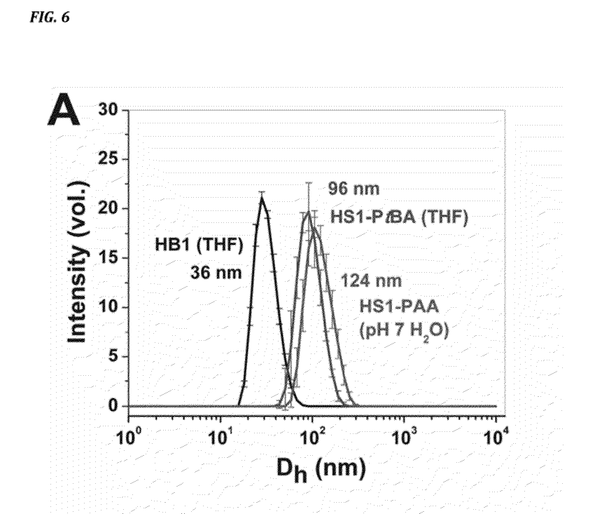

The hyperbranched polymers synthesized by using controlled living radical polymerization techniques well retain the chain-end functionalities and therefore they can be used as macroinitiator for chain extension reactions. For example, the hyperbranched polymer synthesized during Example 2 was used as macroinitiator for polymerization oft-butyl acrylate (tBA). The scheme of this chain extension reaction is shown in FIG. 5. The theoretic number of initiating sites per polymer was assumed to be equal to the average number of inimer units. A clean and dry 10 mL Schlenk flask was charged with 50 mg hyperbranched polymer (0.13 mmol Br), tBA (2.8 ml, 0.019 mol), PMDETA (28 μL, 0.13 mmol), and anisole (2.5 ml). The flask was deoxygenated by five freeze-pump-thaw cycles. During the final cycle, the flask was filled with nitrogen before CuBr (17 mg, 0.12 mmol) and CuBr₂ (3.0 mg, 13 μmol) were quickly added to the frozen mixture. The flask was sealed with a glass stopper then evacuated and back-filled with nitrogen five times before it was immersed in an oil bath at 60° C. Samples were withdrawn periodically for GC and GPC measurements of monomer conversions and polymer molecular weights. The reaction was stopped after 6 hours via exposure to air and dilution with THF. The solution was filtered through a column filled with neutral alumina to remove the copper complex before the polymer was precipitated in cold methanol. The size measurement of the initial hyperbranched polymers, the polymers after poly(tBA) extension, and the polymers after dialysis, was shown in FIG. 6.

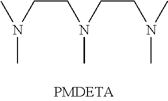

### Example 4

### ATRP of Inimer 5 in Microemulsion

The difference between Inimer 5 and Inimer 1 is the vinyl part: Inimer 5 has an acrylate-based vinyl group while Inimer 1 has a methacrylate-based one. This difference will result in a polymerization rate difference however the hyperbranched polymer should be still produced with a uniform structure.

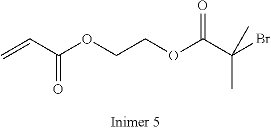

In a polymerization of Inimer 5, the same stoichiometry of ingredients are chosen as in Example 1 and 2, i.e. [Inimer 3]₀/[CuBr₂]₀/[BPMODA]₀/[sodium ascorbate]₀=70/1/1/0.5. Cu(II) complex is first prepared by dissolving equal molar amounts of CuBr₂ and BPMODA ligand into inimer 3 and 0.1 ml methylene chloride at 60° C. After evaporating methylene chloride, the resulting solution is slowly added into 13 ml aqueous solution containing 1 g Brij 98 surfactant to form a thermodynamically stable microemulsion. The microemulsion is purged with nitrogen for 30 minutes before the flask is immersed in an oil bath thermostated at 65° C. 1 ml deoxygenated solution of sodium ascorbate in water is then injected into the reaction to initiate the polymerization. After 2 hours, the reaction is stopped by exposure to air. The synthesized hyperbranched polymer should have number-average molecular weight of about 0.5×10⁶-2×10⁶, from the measurement of THF GPC with MALLS detector, and the molecular weight distribution of this polymer should be between 1.0 and 1.5.

### Example 5

### ATRP of Inimer 1 in Miniemulsion

Microemulsion is only one type of confinement space. The choices of confinement space include other dispersed systems such as miniemulsion. For preparing a miniemulsion, inimer, Cu(II) complex, optional solvent, co-surfactant such as hexadecane, surfactant and water are mixed before the mixture is subject to a high shearing force such as sonication. The resulted mixture is a miniemulsion with a size determined by the ratio of monomer, co-surfactant, surfactant and water. The miniemulsion polymerization can be initiated by injection of a reducing agent such as an aqueous solution of sodium ascorbate. Hyperbranched polymers are produced in each miniemulsion droplet with uniform structure.

The stoichiometry of the polymerization of Inimer 1, 2 or 5 in miniemulsion is very similar to a microemulsion polymerization, i.e. [Inimer 1, 2 or 3]₀/[CuBr₂]₀/[BPMODA]₀/[sodium ascorbate]₀=70/1/1/0.5. However, the amount of surfactant and co-surfactant should be adjusted for a stable miniemulsion. To perform a miniemulsion polymerization of Inimer 1, 2 or 5, a Cu(II) complex is first prepared by dissolving equal molar amounts of CuBr₂ and BPMODA ligand into the inimer, co-stabilizer hexadecane, and a small amount of methylene chloride at 60° C. After evaporating methylene chloride, the resulting solution is slowly added into an aqueous solution containing Brij 98 surfactant. The mixture is under stirring for half an hour before it is subject to sonication (Heat Systems Ultrasonics W-385 sonicator) for 1 min in an ice bath (to prevent a possible temperature rise resulting from sonication) to form a stable miniemulsion. The miniemulsion is purged with nitrogen for 30 minutes before the flask is immersed in an oil bath thermostated at 65° C. A deoxygenated solution of sodium ascorbate in water is then injected into the reaction to initiate the polymerization. After 2 hours, the reaction is stopped by exposure to air. The synthesized hyperbranched polymer should have number-average molecular weight of about 0.5×10⁶-2×10⁶, from the measurement of THF GPC with MALLS detector, and the molecular weight distribution of this polymer should be between 1.0 and 1.5.

### Example 6

### Synthesis Efficiency and Outcomes of Hyperbranched Polymers Using Various Inimers

Hyperbranched polymers were synthesized using the foregoing materials and according to the foregoing methods, with modifications as indicated. Characteristics of the hyperbranched polymers which were produced in these experiments were measured, and the results reported in Table 3.

TABLE 3
Hyperbranched polymers produced by the present methods

| | | | | | Molecular weight | | | DLS size | | | |
|---|---|---|---|---|---|---|---|---|---|---|---|
| | | | | | M_{n,MALLS} | M_{n,RI} | M_{w}/Mₙ | Dₕ (nm)/ | CV/ | Dₕ (nm)/ | CV/ |
| Polymer | Inimer | Surfact. | Ligand | Conv | (×10⁻³) | (×10⁻³) | (RI) | H₂O | H₂O | THF | THF |
| HB1 | 1 | Brij98 | BPMODA | 99% | 1,470 | 140 | 1.24 | 27.0 | 0.18 | 36.0 | 0.12 |
| HB2 | 2 | Brij98 | BPMODA | 97% | 1,510 | 141 | 1.25 | 20.0 | 0.16 | 34.0 | 0.14 |
| HB3 | 3 | Brij98 | dNbpy | 99% | 432 | 51 | 1.19 | 15.5 | 0.12 | 20 | 0.09 |
| HB4 | 4 | Brij98 | dNbpy | 98% | 238 | 51 | 2.1 | 12.4 | 0.20 | 14.1 | 0.20 |

What is claimed is:

1. A hyperbranched polymer of formula 1 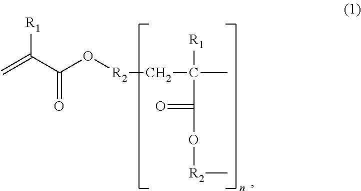
wherein,
n is an integer between 200 and 200,000,
R₁ is —H or —CH₃,
R₂ is selected from the group consisting of a linear, branched or cyclic alkylene group having 1 to 30 carbon atoms, optionally comprising an ester bond, an acetal bond, and a disulfide bond, and
wherein said hyperbranched polymer has a number average molecular weight between about 50,000 and about 5,000,000; and a molecular weight distribution between 1.0 and 1.5, as measured by a gel permeation chromatography in a converted molecular weight as poly(methyl methacrylate).

2. The hyperbranched polymer of claim 1, wherein R₁ is —CH₃.

3. The hyperbranched polymer of claim 2, wherein R₂ comprises an ester bond.

4. The hyperbranched polymer of claim 2, wherein R₂ comprises a disulfide bond.

5. A hyperbranched polymer of formula 2 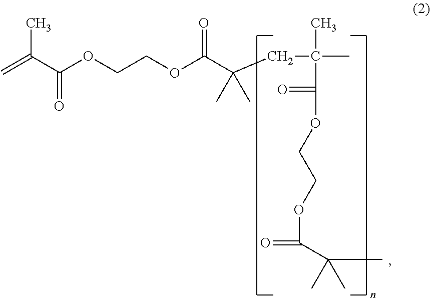
wherein,
n is an integer between 200 and 200,000, and said hyperbranched polymer has a number average molecular weight between about 50,000 and about 5,000,000; and a molecular weight distribution between 1.0 and 1.5, as measured by a gel permeation chromatography in a converted molecular weight as poly(methyl methacrylate).

6. A process of synthesizing a hyperbranched polymer having a uniform structure, comprising:
mixing an inimer mixture comprising (a) an inimer comprising a polymerizable vinyl bond and a functional group of a radically transferable atom, (b) a transition metal compound, and (c) a nitrogen-containing ligand, and a continuous phase mixture optionally comprising a surfactant until a microemulsion is formed,
adding a reducing agent reagent comprising a reducing agent and optionally a solvent to said microemulsion under an inert atmosphere to allow reaction to occur, and holding the reaction under an inert atmosphere.

7. The process of claim 6, wherein said hyperbranched polymer is purified.

8. The process of claim 6, wherein said hydrophobic inimer is a compound of formula 3

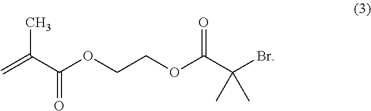

9. The process of claim 6, wherein said transferable atom is a halide.

10. The process of claim 9, wherein said halide is a bromide.

11. The process of claim 6, wherein said transitional metal compound is a cupric halide.

12. The process of claim 11, wherein said cupric halide is a cupric bromide.

13. The process of claim 6, wherein said nitrogen-containing ligand is a compound of formula 4

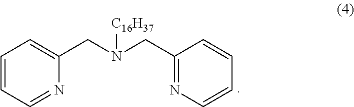

14. The process of claim 6, wherein said mixing is performed at about 65° C.

15. The process of claim 6, wherein said surfactant is non-ionic.

16. The process of claim 15, wherein said surfactant is polyoxyethlyen(20) oley ether.

17. The process of claim 6, wherein said inert atmosphere is nitrogen atmosphere.

18. The process of claim 6, wherein said reducing agent is sodium ascorbate.

19. The process of claim 6, wherein said solvent is water.

20. A process of synthesizing a hyperbranched polymer having a uniform structure, comprising:
mixing an inimer mixture comprising an inimer of formula 3 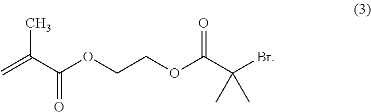
cupric bromide, and a nitrogen-containing ligand of formula 4 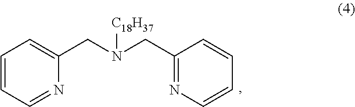
and a deoxygenated aqueous mixture comprising a surfactant of polyoxyethlyen(20) oley ether and water,
at 65° C. until a microemulsion is formed,
adding an aqueous solution of sodium to said microemulsion at 65° C. to allow reaction to occur, and holding the reaction under nitrogen atmosphere at 65° C. for 30 minutes,
exposing said reaction to atmospheric air, mixing said reaction with methanol and obtaining said polymer in precipitation.
